(19) United States
(12) Patent Application Publication
(10) Pub. No.: US 2026/0340594 A1
(43) Pub. Date: Oct. 29, 2026

(54) PREDICTIVE MAINTENANCE SYSTEM FOR BUILDING EQUIPMENT WITH EFFICIENT RESOURCE ALLOCATION

(71) Applicant: Tyco Fire & Security GmbH, Neuhausen am Rheinfall (CH)

(72) Inventors: Josip Lazarevski, Zurich (CH); Parag Datir, Pune (IN); Shawn Tinsley, Longwood, FL (US)

(21) Appl. No.: 19/188,525

(22) Filed: Apr. 24, 2025

(51) Int. Cl. G06Q 10/20; G05B 23/02

(52) U.S. Cl. CPC G06Q 10/20; G05B 23/0243; G05B 23/0283

(57) ABSTRACT

A method includes obtaining a plurality of types of equipment operating data characterizing operation of a plurality of devices of equipment distributed across a plurality of equipment sites, detecting a plurality of faults in the operation of the plurality of devices of equipment based on the equipment operating data, generating a plurality of resource scores, each resource score indicative of a potential level of efficiency associated with dispatching a service provider to service a fault of the plurality of faults associated with one of the plurality of devices of equipment, comparing a resource score for each fault to a threshold value, and initiating an automated action to cause a service provider to be dispatched to a location of the one of the plurality of devices of equipment based on a determination that the resource score for the fault is at or above a threshold value.

### BACKGROUND

Equipment installed at various equipment sites (e.g., building sites, work sites, industrial sites, mining sites, etc.) have varying maintenance requirements may require a service technician to be dispatched to service the equipment on site. In some situations, it may not be an efficient use or allocation of resources to dispatch a service technician to an equipment site, and the equipment can be serviced remotely instead. It can be difficult to determine whether a fault should be serviced on-site or remotely.

### SUMMARY

At least one embodiment relates to a method. The method includes obtaining a plurality of types of equipment operating data characterizing operation of a plurality of devices of equipment distributed across a plurality of equipment sites, detecting a plurality of faults in the operation of the plurality of devices of equipment based on the equipment operating data, generating a plurality of resource scores, each resource score indicative of a potential level of efficiency associated with dispatching a service provider to service a fault of the plurality of faults associated with one of the plurality of devices of equipment, comparing a resource score for each fault to a threshold value, and initiating an automated action to cause a service provider to be dispatched to a location of the one of the plurality of devices of equipment based on a determination that the resource score for the fault is at or above a threshold value.

In some embodiments, the method includes ranking the plurality of faults based on the plurality of resource scores and dispatching a plurality of service providers to the locations of the plurality of devices according to the ranking of the plurality of faults. In some embodiments, generating the plurality of resource scores includes formatting the plurality of types of equipment operating data associated with each fault of the plurality of faults, generating a dataset including the formatted plurality of types of equipment operating data associated with each fault, and analyzing, using a machine learning model, the formatted plurality of types of equipment operating data associated with each fault to generate a resource score for each fault of the plurality of faults. In some embodiments, analyzing the formatted plurality of types of equipment operating data includes weighting a value of each feature of a plurality of features of the equipment operating data according to information associated with each feature of the plurality of features.

In some embodiments, the method further includes identifying that at least one of the features of the plurality of features is missing from the equipment operating data and generating a value for the missing at least one of the features. In some embodiments, initiating the automated action includes causing one or more service technicians to perform one or more service activities to resolve the fault. In some embodiments, the plurality of types of equipment operating data include: fault code data, penalty data, warranty data, service recommendation data, or service record data.

In some embodiments, the method further includes, based on a determination that the resource score for the fault is below the threshold value, at least one of: adding the fault to a queue of faults to be addressed after each fault having a resource score above the threshold value is addressed or initiating an automated action to cause the fault to be resolved remotely.

Another aspect relates to a system. The system includes a plurality of devices of equipment distributed across a plurality of equipment sites and a controller including one or more memories storing instructions thereon that, when executed by one or more processors, cause the one or more processors to: obtain a plurality of types of equipment operating data characterizing operation of the plurality of devices of equipment, detect a plurality of faults in the operation of the plurality of devices of equipment based on the equipment operating data, generate a plurality of resource scores, each resource score indicative of a potential level of efficiency associated with dispatching a service provider to service a fault of the plurality of faults associated with one of the plurality of devices of equipment, compare a resource score for each fault to a threshold value, and initiate an automated action to cause a service provider to be dispatched to a location of the one of the plurality of devices of equipment based on a determination that the resource score for the fault is at or above a threshold value.

In some embodiments, the instructions further cause the one or more processors to: rank the plurality of faults based on the plurality of resource scores and dispatch a plurality of service providers to the locations of the plurality of devices according to the ranking of the plurality of faults. In some embodiments, generating the plurality of resource scores includes: formatting the plurality of types of equipment operating data associated with each fault of the plurality of faults, generating a dataset comprising the formatted plurality of types of equipment operating data associated with each fault, and analyzing, using a machine learning model, the formatted plurality of types of equipment operating data associated with each fault to generate a resource score for each fault of the plurality of faults. In some embodiments, analyzing the formatted plurality of types of equipment operating data includes: weighting a value of each feature of a plurality of features of the equipment operating data according to information associated with each feature of the plurality of features.

In some embodiments, the instructions further cause the one or more processors to: identify that at least one of the features of the plurality of features is missing from the equipment operating data and generate a value for the missing at least one of the features. In some embodiments, initiating the automated action includes causing one or more service technicians to perform one or more service activities to resolve the fault. In some embodiments, the plurality of types of equipment operating data includes: fault code data, penalty data, warranty data, service recommendation data, or service record data.

In some embodiments, the instructions further cause the one or more processors to, based on a determination that the resource score for the fault is below the threshold value, at least one of: add the fault to a queue of faults to be addressed after each fault having a resource score above the threshold value is addressed or initiate an automated action to cause the fault to be resolved remotely.

Another aspect relates to one or more non-transitory computer-readable media storing instructions thereon that, when executed by one or more processors, cause the one or more processors to: obtain a plurality of types of equipment operating data characterizing operation of a plurality of devices of equipment distributed across a plurality of equipment sites, detect a plurality of faults in the operation of the plurality of devices of equipment based on the equipment operating data, generate a plurality of resource scores, each resource score indicative of a potential level of efficiency associated with dispatching a service provider to service a fault of the plurality of faults associated with one of the plurality of devices of equipment, compare a resource score for each fault to a threshold value, and initiate an automated action to cause a service provider to be dispatched to a location of the one of the plurality of devices of equipment based on a determination that the resource score for the fault is at or above a threshold value.

In some embodiments, the instructions further cause the one or more processors to: rank the plurality of faults based on the plurality of resource scores and dispatch a plurality of service providers to the locations of the plurality of devices according to the ranking of the plurality of faults. In some embodiments, generating the plurality of resource scores includes formatting the plurality of types of equipment operating data associated with each fault of the plurality of faults, generating a dataset comprising the formatted plurality of types of equipment operating data associated with each fault, and analyzing, using a machine learning model, the formatted plurality of types of equipment operating data associated with each fault to generate a resource score for each fault of the plurality of faults. In some embodiments, analyzing the formatted plurality of types of equipment operating data includes: weighting a value of each feature of a plurality of features of the equipment operating data according to information associated with each feature of the plurality of features.

In some embodiments, the instructions further cause the one or more processors to: identify that at least one of the features of the plurality of features is missing from the equipment operating data and generate a value for the missing at least one of the features. In some embodiments, initiating the automated action includes causing one or more service technicians to perform one or more service activities to resolve the fault.

### BRIEF DESCRIPTION OF THE DRAWINGS

FIG. 1 is a drawing of a building equipped with a heating, ventilation, and/or air conditioning (HVAC) system, according to an exemplary embodiment.

FIG. 2 is a schematic diagram of a waterside system which can be used in conjunction with the building of FIG. 1, according to some embodiments.

FIG. 3 is a schematic diagram of an airside system which can be used in conjunction with the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1 and includes a predictive maintenance system, according to some embodiments.

FIG. 6A is a block diagram of another BMS including the predictive maintenance system for optimizing service schedules, according to some embodiments.

FIG. 6B is a block diagram of another BMS including the predictive maintenance system for optimizing service schedules, according to some embodiments.

FIG. 7 is a block diagram of a predictive maintenance system for connected equipment, according to some embodiments.

FIG. 8 illustrates an architecture of the predictive maintenance system of FIG. 7, according to some embodiments.

FIG. 9 illustrates service report data which can be utilized by the predictive maintenance system of FIG. 7, according to some embodiments.

FIG. 10 illustrates service report data which can be utilized by the predictive maintenance system of FIG. 7, according to some embodiments.

FIG. 11 illustrates an equipment performance index data which can be utilized by the predictive maintenance system of FIG. 7, according to some embodiments.

FIG. 12 illustrates an method for generating resource scores, according to some embodiments.

### DETAILED DESCRIPTION

Referring generally to the FIGURES, systems and methods are provided for an integrated global chiller maintenance scheduling system with virtual inspection report optimization.

Pieces of building equipment can experience faults that require maintenance or servicing by a technician to resolve. It can be difficult to determine whether a service technician should be dispatched to a location of the equipment or remotely service the equipment.

Technically and beneficially, the systems and methods described herein provide an automated manner of determining whether to dispatch a service provider to service a piece of building equipment. Scores are generated for equipment faults that determine a rank or priority of the faults based on a likelihood of dispatching a service provider to be an efficient use of service provider resources, thereby prioritizing service provider dispatch to faults determined to have a higher or greater associated efficiency when a service provider is dispatched to service the fault. Further, costs can be reduced and efficiency can be increased by eliminating service provider dispatches to equipment sites that can be handled remotely or serviced at a later date.

Further, the systems and methods described herein provide for faster servicing of high importance or critical faults. For example, automatically ranking faults using information including a criticality or severity of the fault can cause a service provider to be dispatched to that fault more quickly. Advantageously, the system described herein optimally allocates service provider resources and makes use of remote diagnostics, automatic repairs, and remote fixes when possible to ensure that faults in devices of equipment are repaired quickly and efficiently while minimizing or reducing the need for human intervention. This reduces the amount of time that the devices of equipment operate in a fault state or are rendered inoperable by unrepaired faults. The repaired devices of equipment may operate more efficiently and reliably, which leads to less energy consumption, reduced carbon emissions, less downtime, and other technical improvements. These and other improvements and advantages are described in detail throughout the present disclosure.

### Building HVAC Systems and Building Management Systems

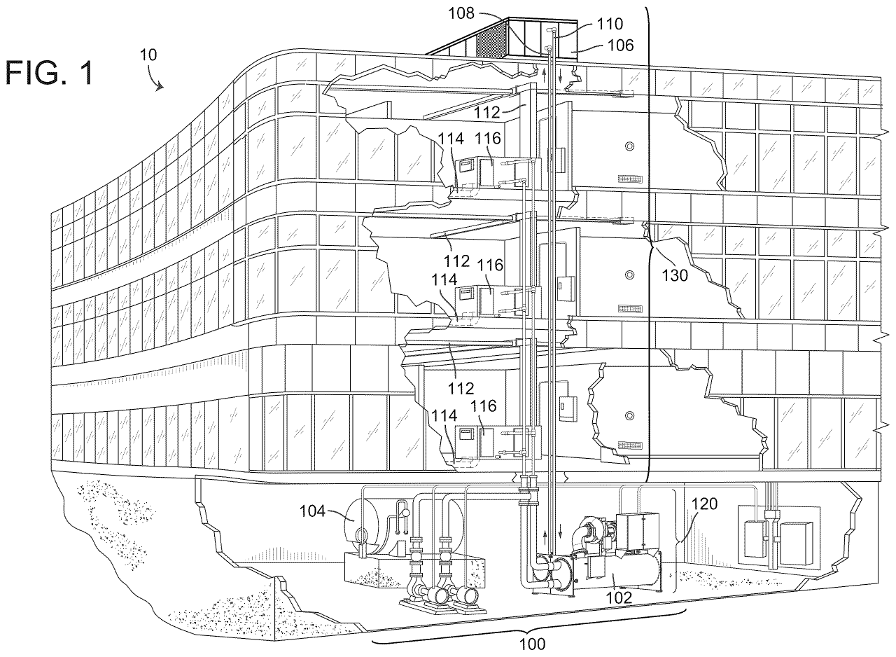

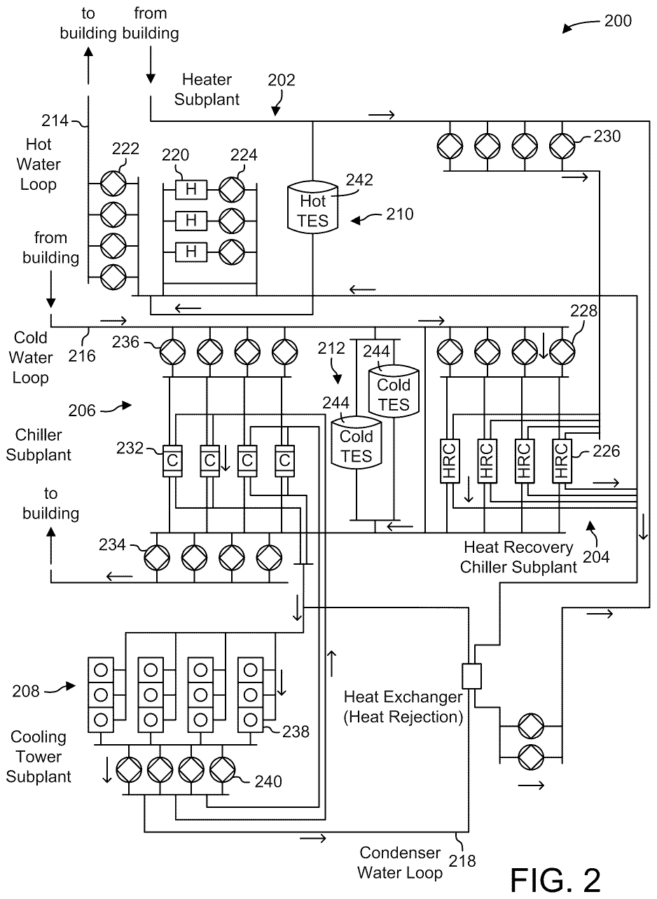

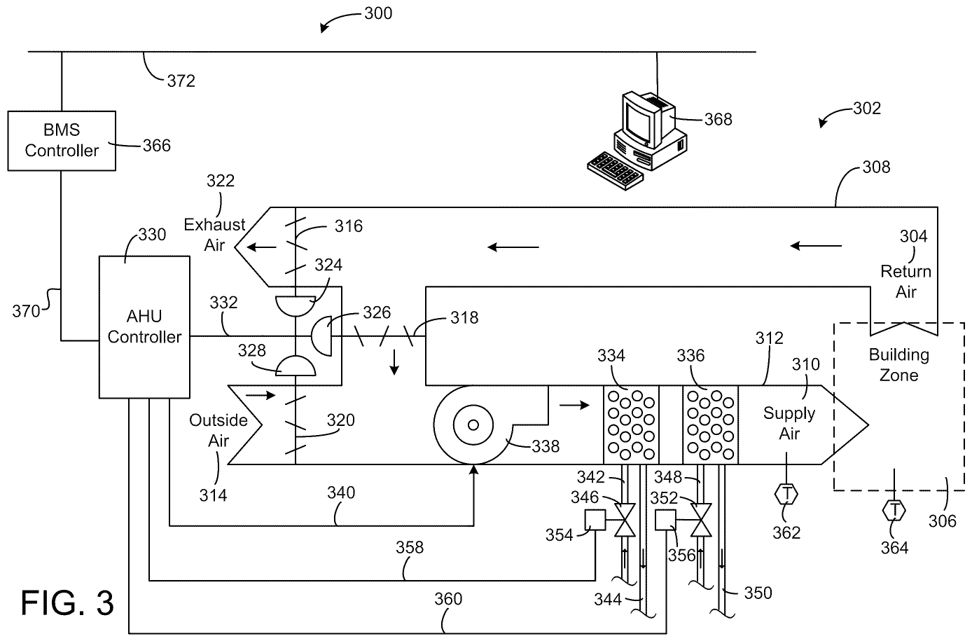

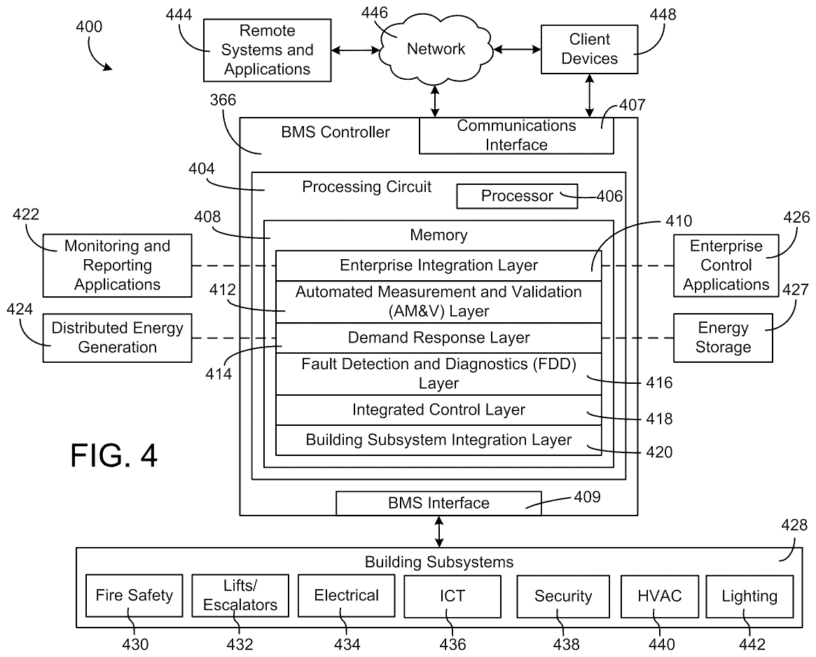

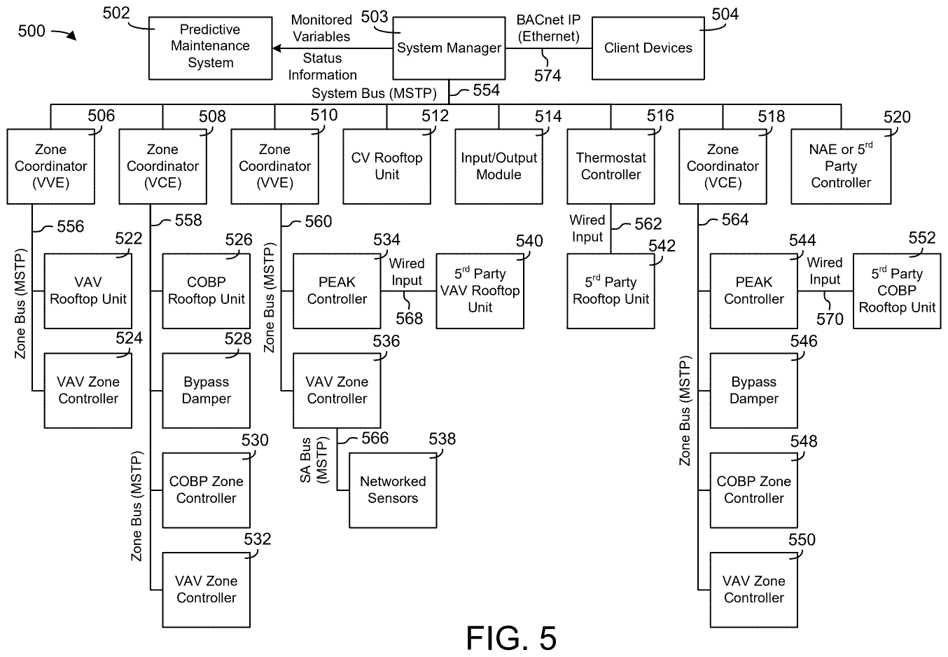

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building 10 and HVAC System 100

Referring particularly to FIG. 1, a perspective view of building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2 and 3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System 200

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System 300

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust air damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management System 400

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, thermostats, and other devices for controlling the temperature, humidity, airflow, or other variable conditions within building 10. Lighting subsystem 442 can include any number of light fixtures, ballasts, lighting sensors, dimmers, and/or other devices configured to controllably adjust the amount of light provided to a building space. Security subsystem 438 can include occupancy sensors, video surveillance cameras, digital video recorders, video processing servers, intrusion detection devices, access control devices and servers, and/or other security-related devices.

Still referring to FIG. 4, BMS controller 366 is shown to include a communications interface 407 and a BMS interface 409. Communications interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Communications interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Communications interfaces 407 and/or BMS interface 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via communications interfaces 407 and/or BMS interface 409 can be direct (e.g., local wired or wireless communications) or via a communications network 446 (e.g., a WAN, the Internet, a cellular network, etc.). For example, communications interfaces 407 and/or BMS interface 409 can include an Ethernet card and port for sending and receiving data via an Ethernet-based communications link or network. In another example, communications interfaces 407 and/or BMS interface 409 can include a Wi-Fi transceiver for communicating via a wireless communications network. In another example, one or both of communications interfaces 407 and BMS interface 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that the processing circuit 404 and the various components thereof can send and receive data via communications interfaces 407 and/or BMS interface 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations).

Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at communications interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES tank 242, cold TES tank 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs (e.g., internal to building 10, external to building 10, etc.) such as temperature, carbon dioxide levels, relative humidity levels, air quality sensor outputs, occupancy sensor outputs, room schedules, weather conditions, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints, etc.) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface, etc.) so that the control actions initiated in response to demand inputs can be tailored for the user's application, desired comfort level, particular building equipment, and/or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and/or when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems.

For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, and/or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage, etc.) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Several examples of FDD models and processes that can be used by the BMS 400 are described in detail in U.S. Pat. No. 10,969,775 granted Apr. 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. Pat. No. 10,747,187 granted Aug. 18, 2020, U.S. Pat. No. 9,753,455 granted Sep. 5, 2017, and U.S. Pat. No. 8,731,724 granted May 20, 2014. The entire disclosures of each of these patents are incorporated by reference herein. The BMS 400 can use these or other FDD models or processes to help diagnose the root causes of problems associated with the building equipment and identify the particular actions that can be taken by the BMS 400 or by service providers (e.g., performing service on building equipment, repairing or replacing building equipment, switching to a new control strategy, automatically updating device software or firmware, etc.) to improve the performance of the building equipment and resolve the problems associated with the service requests and/or service reports for the building equipment.

In some embodiments, the BMS 400 may have associated warranty data. In some embodiments, the warranty data include reliability data that indicate the failure rates, expected time until failure, or other reliability metrics of various types of building equipment (e.g., particular equipment models) or components thereof. The reliability data can be generated from a set of service actions performed by a manufacturer or service provider and/or warranty claims submitted by various customers across a large set of building equipment over time. In some embodiments, the warranty data include freeform text included in warranty claims, photographs or videos of failed equipment, service reports generated when performing service on equipment under warranty, or any other type of data associated with equipment under warranty. These and other examples of warranty data are described in greater detail in U.S. patent application Ser. No. 17/971,342 filed Oct. 21, 2022, U.S. patent application Ser. No. 18/116,974 filed Mar. 3, 2023, U.S. patent application Ser. No. 17/530,257 filed Nov. 18, 2021, and Singapore Patent Application No. 10202250321D filed Jun. 28, 2022, the entire disclosures of which are incorporated by reference herein. The warranty data can include structured and/or unstructured data of any type or format.

### Building Management System 500

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment. In some embodiments, the building management system includes a predictive maintenance system 502.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a predictive maintenance system 502, a system manager 503; several zone coordinators 506, 508, 510 and 518; and several zone controllers 524, 530, 532, 536, 548, and 550. System manager 503 can monitor various data points in BMS 500 and report monitored variables to predictive maintenance system 502. System manager 503 can communicate with client devices 504 (e.g., user devices, desktop computers, laptop computers, mobile devices, etc.) via a data communications link 574 (e.g., BACnet IP, Ethernet, wired or wireless communications, etc.). System manager 503 can provide a user interface to client devices 504 via data communications link 574. The user interface may allow users to monitor and/or control BMS 500 via client devices 504.

In some embodiments, system manager 503 is connected with zone coordinators 506-510 and 518 via a system bus 554. System manager 503 can be configured to communicate with zone coordinators 506-510 and 518 via system bus 554 using a master-slave token passing (MSTP) protocol or any other communications protocol. System bus 554 can also connect system manager 503 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520.

RTU 512 can be configured to communicate directly with system manager 503 and can be connected directly to system bus 554. Other RTUs can communicate with system manager 503 via an intermediate device. For example, a wired input 562 can connect a third-party RTU 542 to thermostat controller 516, which connects to system bus 554.

System manager 503 can provide a user interface for any device containing an equipment model. Devices such as zone coordinators 506-510 and 518 and thermostat controller 516 can provide their equipment models to system manager 503 via system bus 554. In some embodiments, system manager 503 automatically creates equipment models for connected devices that do not contain an equipment model (e.g., IOM 514, third-party controller 520, etc.). For example, system manager 503 can create an equipment model for any device that responds to a device tree request. The equipment models created by system manager 503 can be stored within system manager 503. System manager 503 can then provide a user interface for devices that do not contain their own equipment models using the equipment models created by system manager 503. In some embodiments, system manager 503 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Predictive Maintenance System for Connected Equipment

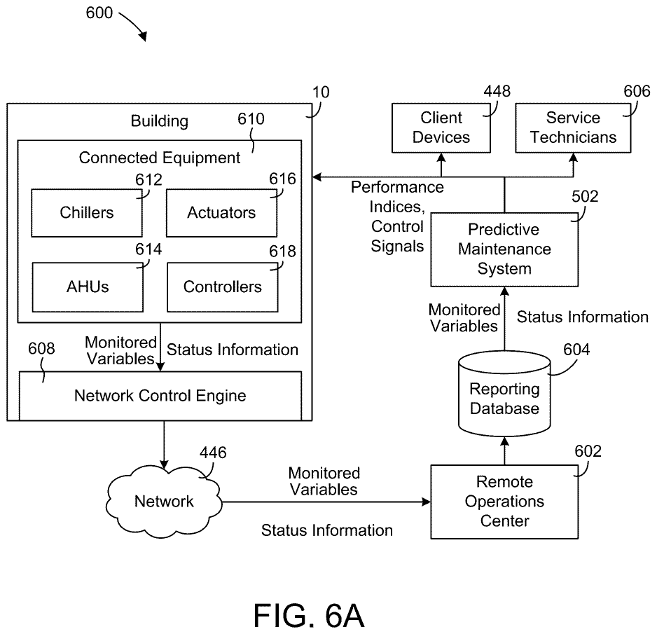

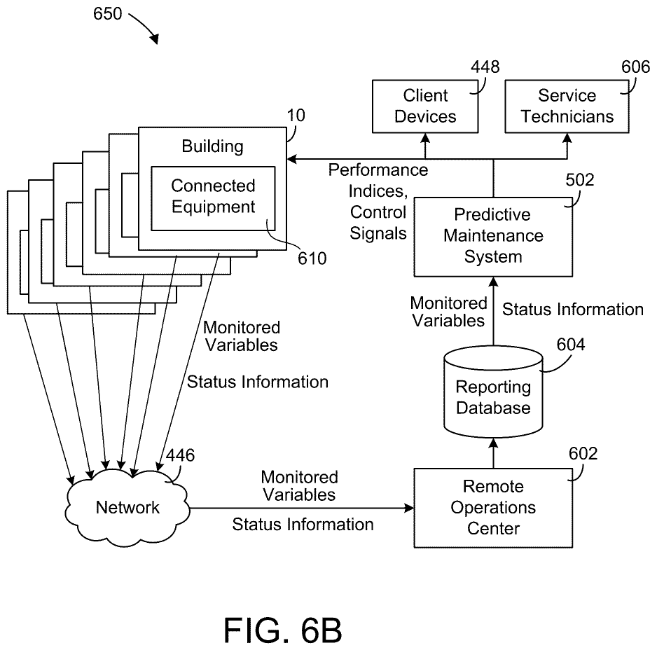

Referring now to FIG. 6A, a block diagram of another building management system (BMS) 600 which includes the predictive maintenance system 502 for determining an optimized servicing schedule is shown, according to some embodiments. BMS 600 can include many of the same components as BMS 400 and BMS 500 as described with reference to FIGS. 4 and 5. For example, BMS 600 is shown to include building 10, network 446, client devices 448, and predictive maintenance system 502. Building 10 is shown to include connected equipment 610, which can include any type of equipment used to monitor and/or control building 10. Connected equipment 610 can include connected chillers 612, connected AHUs 614, connected actuators 616, connected controllers 618, or any other type of equipment in a building HVAC system (e.g., boilers, economizers, valves, dampers, cooling towers, fans, pumps, etc.) or building management system (e.g., lighting equipment, security equipment, refrigeration equipment, etc.). Connected equipment 610 can include any of the equipment of HVAC system 100, waterside system 200, airside system 300, BMS 400, and/or BMS 500, as described with reference to FIGS. 1-5.

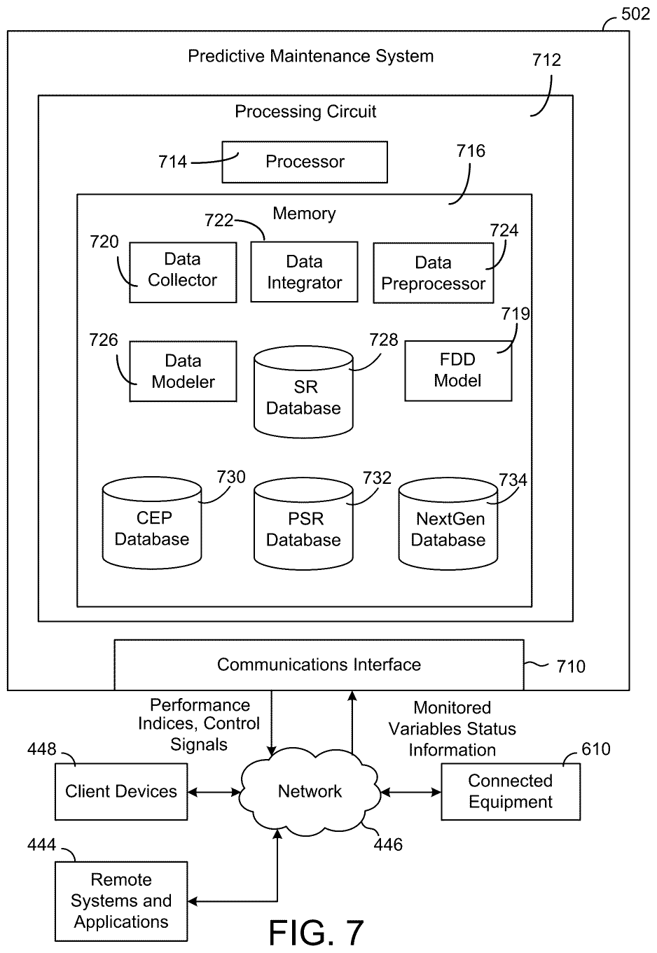

Connected equipment 610 can be outfitted with sensors to monitor particular conditions of the connected equipment 610. For example, chillers 612 can include sensors configured to monitor chiller variables such as chilled water return temperature, chilled water supply temperature, chilled water flow status (e.g., mass flow rate, volume flow rate, etc.), condensing water return temperature, condensing water supply temperature, motor amperage (e.g., of a compressor, etc.), variable speed drive (VSD) output frequency, and refrigerant properties (e.g., refrigerant pressure, refrigerant temperature, condenser pressure, evaporator pressure, etc.) at various locations in the refrigeration circuit. An example of a chiller 700 which can be used as one of chillers 612 is described in greater detail with reference to FIG. 7. Similarly, AHUs 614 can be outfitted with sensors to monitor AHU variables such as supply air temperature and humidity, outside air temperature and humidity, return air temperature and humidity, chilled fluid temperature, heated fluid temperature, damper position, etc. In general, connected equipment 610 monitor and report variables that characterize the performance of the connected equipment 610. Each monitored variable can be forwarded to network control engine 608 as a data point (e.g., including a point ID, a point value, etc.).

Monitored variables can include any measured or calculated values indicating the performance of connected equipment 610 and/or the components thereof. For example, monitored variables can include one or more measured or calculated temperatures (e.g., refrigerant temperatures, cold water supply temperatures, hot water supply temperatures, supply air temperatures, zone temperatures, etc.), pressures (e.g., evaporator pressure, condenser pressure, supply air pressure, etc.), flow rates (e.g., cold water flow rates, hot water flow rates, refrigerant flow rates, supply air flow rates, etc.), valve positions, resource consumptions (e.g., power consumption, water consumption, electricity consumption, etc.), control setpoints, model parameters (e.g., regression model coefficients, etc.), and/or any other time-series values that provide information about how the corresponding system, device, and/or process is performing. Monitored variables can be received from connected equipment 610 and/or from various components thereof. For example, monitored variables can be received from one or more controllers (e.g., BMS controllers, subsystem controllers, HVAC controllers, subplant controllers, AHU controllers, device controllers, etc.), BMS devices (e.g., chillers, cooling towers, pumps, heating elements, etc.), and/or collections of BMS devices.

Connected equipment 610 can also report equipment status information. Equipment status information can include, for example, the operational status of the equipment, an operating mode (e.g., low load, medium load, high load, etc.), an indication of whether the equipment is running under normal or abnormal conditions, a safety fault code, and/or any other information that indicates the current status of connected equipment 610. In some embodiments, equipment status information reported by the connected equipment 610 is in the form of status codes. For example, four types of status codes can be reported by a connected equipment (e.g., chiller), including safety shutdown codes (safety codes), warning codes, cycling codes, and operation codes. The status codes are described in greater detail herein below in this disclosure.

In some embodiments, each device of connected equipment 610 includes a control panel. The control panel can use the sensor data to shut down the device if the control panel determines that the device is operating under unsafe conditions. For example, the control panel can compare the sensor data (or a value derived from the sensor data) to predetermined thresholds. If the sensor data or calculated value crosses a safety threshold, the control panel can shut down the device and/or operate the device at a derated setpoint. The control panel can generate a data point when a safety shut down or a derate occurs. The data point can include a safety fault code which indicates the reason or condition that triggered the shut down or derate.

Connected equipment 610 can provide monitored variables and equipment status information to a network control engine 608. Network control engine 608 can include a building controller (e.g., BMS controller 366), a system manager (e.g., system manager 503), a network automation engine (e.g., NAE 520), or any other system or device of building 10 configured to communicate with connected equipment 610. In some embodiments, the monitored variables and the equipment status information are provided to network control engine 608 as data points. Each data point can include a point ID and/or a point value. The point ID can identify the type of data point and/or a variable measured by the data point (e.g., condenser pressure, refrigerant temperature, fault code, etc.). Monitored variables can be identified by name or by an alphanumeric code (e.g., Chilled_Water_Temp, 7694, etc.). The point value can include an alphanumeric value indicating the current value of the data point (e.g., 44 °F, fault code 4, etc.).

Network control engine 608 can broadcast the monitored variables and the equipment status information to a remote operations center (ROC) 602. ROC 602 can provide remote monitoring services and can send an alert to building 10 in the event of a critical alarm. ROC 602 can push the monitored variables and equipment status information to a reporting database 604, where the data is stored for reporting and analysis. Predictive maintenance system 502 can access database 604 to retrieve the monitored variables and the equipment status information.

In some embodiments, predictive maintenance system 502 is a component of BMS controller 366 (e.g., within FDD layer 416). For example, predictive maintenance system 502 can be implemented as part of a METASYS® brand building automation system, as sold by Johnson Controls Inc. In other embodiments, predictive maintenance system 502 can be a component of a remote computing system or cloud-based computing system configured to receive and process data from one or more building management systems. For example, predictive maintenance system 502 can connect the connected equipment 610 (e.g., chillers 612) to the cloud and collect real-time data for over a number of points (e.g., 50 points) on those equipment. In other embodiments, predictive maintenance system 502 can be a component of a subsystem level controller (e.g., a HVAC controller, etc.), a subplant controller, a device controller (e.g., AHU controller 330, a chiller controller, etc.), a field controller, a computer workstation, a client device, and/or any other system and/or device that receives and processes monitored variables from connected equipment 610.

Predictive maintenance system 502 may use the monitored variables to identify a current operating state of connected equipment 610. The current operating state can be examined by predictive maintenance system 502 to expose when connected equipment 610 begins to degrade in performance and/or to predict when faults will occur. In some embodiments, predictive maintenance system 502 determines whether the current operating state is a normal operating state or a faulty operating state. Predictive maintenance system 502 may report the current operating state and/or the predicted faults to client devices 448, service technicians 606, building 10, and/or any other system and/or device. Communications between the predictive maintenance system 502 and other systems and/or devices can be direct and/or via an intermediate communications network, such as network 446. If the current operating state is identified as a faulty state or moving toward a faulty state, the predictive maintenance system 502 may generate an alert or notification for service technicians 606 to repair the fault or potential fault before it becomes more severe. In some embodiments, the predictive maintenance system 502 uses the current operating state to determine an appropriate control action for connected equipment 610.

In some embodiments, the predictive maintenance system 502 provides a web interface which can be accessed by service technicians 606, client devices 448, and other systems or devices. The web interface can be used to access the raw data in reporting database 604, view the results produced by the predictive maintenance system, identify equipment in need of preventive maintenance, and otherwise interact with the predictive maintenance system 502.

Service technicians 606 can access the web interface to view a list of equipment for which faults are predicted by the predictive maintenance system 502. Service technicians 606 can use the predicted faults to proactively repair connected equipment 610 before a fault and/or an unexpected shut down occurs. These and other features of the predictive maintenance system 502 are described in greater detail below.

Referring now to FIG. 6B, a block diagram of another building management system (BMS) 650 is shown, according to some embodiments. The building management system 650 of FIG. 6B includes the components of the building management system 600 of FIG. 6A, plus any number of additional buildings 10 with additional groups of connected equipment 610. The multiple buildings 10 and multiple units of connected 610 can be considered as a fleet of buildings and/or equipment. The buildings 10 and connected equipment 610 can be located in one location (e.g., one campus) or multiple locations, including across geographic regions, states, provinces, territories, countries, continents, etc. FIG. 6B illustrates that the network 446 can connect all such buildings 10 and connected equipment 610 to the remote operations center 602 (e.g., via the Internet). Data from the multiple sets of connected equipment 610 that serve different buildings 10 can be aggregated, tagged, filtered, displayed on dashboards, etc. in order to provide a wide variety of fleet analytics and insights into operation of the building management system 650 and the connected equipment 610.

Referring now to FIG. 7, a block diagram illustrating predictive maintenance system 502 in greater detail is shown, according to some embodiments. Predictive maintenance system 502 is shown to include a communications interface 710 and a processing circuit 712.

Communications interface 710 may facilitate communications between predictive maintenance system 502 and various external systems or devices. For example, predictive maintenance system 502 may receive the monitored variables from connected equipment 610 and provide control signals, performance indices, and/or other information of detected faults to connected equipment 610 via communications interface 710. Communications interface 710 may also be used to communicate with remote systems and applications 444, client devices 448, and/or any other external system or device. For example, predictive maintenance system 502 may provide performance indices and other information of detected faults to remote systems and applications 444, client devices 448, service technicians 606, or any other external system or device via communications interface 710.

Communications interface 710 can include any number and/or type of wired or wireless communications interfaces (e.g., jacks, antennas, transmitters, receivers, transceivers, wire terminals, etc.). For example, communications interface 710 can include an Ethernet card and port for sending and receiving data via an Ethernet-based communications link or network. As another example, communications interface 710 can include a Wi-Fi transceiver, a NFC transceiver, a cellular transceiver, a mobile phone transceiver, or the like for communicating via a wireless communications network. In some embodiments, communications interface 710 includes RS232 and/or RS485 circuitry for communicating with BMS devices (e.g., chillers, controllers, etc.). Communications interface 710 can be configured to use any of a variety of communications protocols (e.g., BACnet, Modbus, N2, MSTP, Zigbee, etc.). Communications via interface 710 can be direct (e.g., local wired or wireless communications) or via an intermediate communications network 446 (e.g., a WAN, the Internet, a cellular network, etc.). Communications interface 710 can be communicably connected with processing circuit 712, and the various components thereof can send and receive data via communications interface 710.

Processing circuit 712 is shown to include a processor 714 and memory 716. Processor 714 can be implemented as a general purpose processor, an application specific integrated circuit (ASIC), one or more field programmable gate arrays (FPGAs), a group of processing components, or other suitable electronic processing components. Memory 716 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 716 can be or include volatile memory or non-volatile memory. Memory 716 can include database components, object code components, script components, or any other type of information structure for supporting the various activities and information structures described in the present application. According to some embodiments, memory 716 is communicably connected to processor 714 via processing circuit 712 and includes computer code for executing (e.g., by processing circuit 712 and/or processor 714) one or more processes described herein.

Still referring to FIG. 7, in some embodiments, the memory 716 can include at least a fault detection and diagnostic (FDD) model 719, data collector 720, a data integrator 722, a data preprocessor 724, and a data modeler 726. The memory 716 can further include a service report (SR) database 728, a connected equipment portal (CEP) database 730, a proactive service recommendation (PSR) database 732, and a NextGen database 734. In other embodiments, more, fewer, or different modules or components can be stored in memory 716. In some embodiments, the modules 719-734 can be implemented in one apparatus. In other embodiments, each of the modules 719-734 can be implemented in different and separate apparatuses and/or executed by different and separate processors, or a combination thereof. In some embodiments, modules 719-734 stored in a non-transitory computer readable medium (e.g., memory 716) can be executed by the processor 714 to perform operations as described herein. In some embodiments, each of the modules 719-734 or a combination of some of the modules 719-734 can be implemented as hardware circuits.

The predictive maintenance system 502 may be configured to determine an efficiency associated with dispatching a service provider to service a piece of building equipment. As described herein, efficiency may refer to any number of types of efficiency, such as cost-effectiveness, workflow efficiency, energy efficiency, equipment service response times, and the like. Specifically, the predictive maintenance system 502 may generate a resource score for each piece of building equipment experiencing a fault and determine, based on the resource score, whether a service provider should be dispatched to service the equipment. Servicing equipment based on the resource score may improve operation of building equipment, improve equipment efficiency, improve workflow efficiency, etc.

In some embodiments, the predictive maintenance system 502 may include a fault detection and diagnostic (FDD) model 719 that can be used by the predictive maintenance system 502 to detect faults or problems associated with the building equipment, predict the root causes of the faults or problems, and/or determine actions that are predicted to resolve the root causes of the faults or problems. The FDD model 719 may be implemented as one or more models or processes. In some embodiments, the FDD model 719 require additional information or data not included in the service requests or service reports. The predictive maintenance system 502 can automatically gather the additional information or data needed by the FDD model 719 and provide the additional information as inputs to support the FDD activities. Several examples of FDD models and processes that can be used by the predictive maintenance system 502 are described in detail in U.S. Pat. No. 10,969,775 granted April 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. Pat. No. 10,747,187 granted Aug. 18, 2020, U.S. Pat. No. 9,753,455 granted Sep. 5, 2017, and U.S. Pat. No. 8,731,724 granted May 20, 2014. The entire disclosures of each of these patents are incorporated by reference herein. The predictive maintenance system 502 can use these or other FDD models or processes to help diagnose the root causes of problems associated with the building equipment and identify the particular actions that can be taken by the predictive maintenance system 502 or by service providers (e.g., performing service on building equipment, repairing or replacing building equipment, switching to a new control strategy, automatically updating device software or firmware, etc.) to improve the performance of the building equipment and resolve the problems associated with the service requests and/or service reports for the building equipment.

The data collector 720 may collect data from one or more of the databases 728-734. Specifically, the data collector 720 collects data from one of more of the databases 728-734 relevant to assessing the efficiency of a truck roll (e.g., service provider dispatch). The data collector 720 identifies relevant data and their sources (e.g., for historical data extraction). As will be described herein, the data may be integrated into a central data repository, thereby streamlining data retrieval and enhancing efficiency.

The SR database 728 includes service record data. Service record data may include a description of a fault of a piece of building equipment. In some embodiments, the service record data may include information input or generated by a customer (e.g., a building manager, etc. that has building equipment installed in a building). For example, a piece of building equipment may be experiencing a fault or a failure (e.g., a malfunction, a broken component, etc.). As such, the customer may submit a service request ticket describing the fault that is sent to a service technician.

In some embodiments, the service record data may include information input or generated by a service technician. For example, as described above, a customer may submit a service request ticket. A service technician may travel to a location of the building equipment to perform maintenance on the building equipment (and/or service the equipment remotely). The service record data may therefore include a description of the fault and any steps the technician performs to service the building equipment. In various embodiments, the service record data may include both information from a customer and information from a service technician.

The service record data may be generated based on recommendations of virtual service inspections. For example, building equipment may be virtually serviced and/or inspected, and service record data may be generated based on the services performed during the inspection. Alternatively, a customer may reach out to the service provider and request service. The service provider may create a service request based on one or both of the virtual service inspection data and the customer request.

The service record data may include historical fault and/or service information for the building equipment. For example, the service record data may include information from every ticket that has been submitted, every fault experienced by the building equipment, every maintenance operation and/or inspection performed by a technician, etc.

In some embodiments, the service record data may also include service record financial data. For example, the as described above, the service record data may include written descriptions of faults experienced by the building equipment and/or services performed on the equipment. For each description of a fault, the service record data may include a total amount of revenue associated with the building equipment and/or fault. For example, the total revenue may indicate revenue lost by not servicing the equipment, revenue gained by servicing previously out-of-order equipment, etc. The total revenue may be for a certain period of time (e.g., total revenue associated with the building equipment for one month, etc.).

The CEP database 730 may include information relating to building equipment performance. For example, in embodiments in which the building equipment is a chiller, the CEP database 730 may include chiller performance index (CPI) data. The building equipment performance information (e.g., CPI data) may include, for example, fault codes of faults associated with the building equipment, penalties associated with the building equipment, a number of penalty occurrences for the building equipment, etc.

The CEP database 730 may include equipment performance index information. For example, an equipment performance index may be a numerical value that is an aggregate of equipment data for a piece of equipment. The performance index may be indicative of performance, reliability, and/or efficiency of the equipment. The performance index may indicate that the performance of the equipment is acceptable, in an alert state (e.g., the equipment may be or will, in the future, be performing poorly), or an alarm state (e.g., the equipment needs servicing). The equipment performance index may indicate performance on a per-month basis. In some embodiments, the equipment performance index may be generated using the techniques described in U.S. Pat. No. 11,630,453 granted Apr. 18, 2023, the entire disclosure of which is incorporated by reference herein.

The PSR database 732 includes proactive service recommendation trigger information. That is, the PSR database 732 may include recommendations regarding service of a piece of building equipment. For example, when a fault is generated for a piece of building equipment, the PSR data may highlight or otherwise indicate that the equipment should be serviced. The PSR data may include a recommendation of how the building equipment should be serviced. A service technician may receive the PSR information and service or inspect the building equipment according to the recommendation generated and indicated in the PSR database 732. The PSR trigger information may be based on individual data for each piece of building equipment. For example, the PSR data (e.g., a provided recommendation for a piece of building equipment) may be based on behavior exhibited by the building equipment.

The NextGen database 734 may include planned service agreement (PSA) and warranty information. Specifically, the NextGen database 734 may include information relating to a warranty status, warranty coverage type, etc. of pieces of building equipment. The NextGen database 734 may also include contract data for pieces of building equipment.

Warranty information may also include information about building equipment that has experienced component failure which may be repaired under a warranty agreement. Warranty information may also include warranty claim data that describes (i) an equipment/component identifier, (ii) a ship date (e.g., a date a piece of equipment/component was shipped to an install location, etc.), (iii) a failure date (e.g., a date a piece of equipment/component failed, etc.), (iv) a runtime associated with the equipment/component (e.g., runtime may be equal to the subtraction of the start date from the failure date), (v) a start date (e.g., a date the piece of equipment/component began operating at the install location, etc.), (vi) a manufacturing location identifier, (vii) a product description, and/or (viii) a location identifier associated with the install location (e.g., an address, etc.). Warranty information is described in detail in U.S. patent application Ser. No. 17/971,342, filed Oct. 21, 2022, and U.S. patent application Ser. No. 18/214,945, filed Jun. 27, 2023. The entire disclosures of each of these patents are incorporated by reference herein.

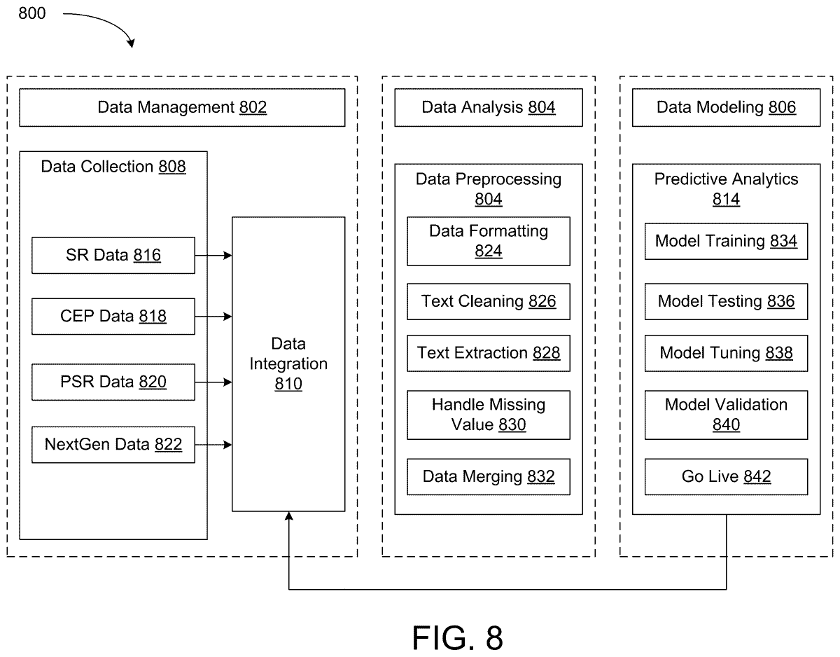

As described above, the data collector 720 may collect any number of pieces of data from one or more of the SR database 728, the CEP database 730, the PSR database 732, and the NextGen database 734. Specifically, the data collector 720 may collect data that is relevant to generating a resource score associated with dispatching a service technician to a faulty piece of building equipment, as described in detail below with reference to FIGS. 7-8. For example, the data collector 720 may analyze each piece of data stored in each of the databases 728-734 and determine whether the data is relevant to the generation of a resource score (e.g., by identifying key words within the data, using similarity thresholds and algorithms, etc.).

The data integrator 722 integrates data collected by the data collector 720 from the databases 728-734. Specifically, the data integrator 722 integrates the collected data into a local central data repository. This may reduce computing resources and processing times associated with generating resource scores and analyzing data, collecting data, retrieving data, etc. For example, data included in the databases 728-734 may include information that is not used or relevant in generating resource scores. As such, collecting relevant data and storing the data in a central data repository may facilitate faster data retrieval, as irrelevant data is not parsed through. In some embodiments, the data collector 720 may collect all data stored in each of the databases 728-734. In such embodiments, the data integrator 722 extracts relevant data from each of the data sources 728-734 (e.g., via analysis using, for example, similarity thresholds, etc.) and integrates the relevant data into a central data repository.

The data preprocessor 724 processes the data collected by the data collector 720 and integrated by the data integrator 722. The data preprocessor 724 preprocesses the data to prepare for use by the data modeler 726 (e.g., a machine learning model) to train the machine learning model and generate resource scores for different building equipment faults.

The data preprocessor 724 first structures the data collected by the data collector 720. For example, the data stored in the central repository (e.g., after being integrated by the data integrator 722) may be structured as one or more tables having rows and columns. The data preprocessor 724 may structure the data to remove or filter out irrelevant content, such that only rows and/or columns containing information needed to generate the resource scores are retained. Further, the data preprocessor 724 may rectify any variables within the dataset(s) having incorrect data types. The data preprocessor 724 may also structure the data into a format that is readable and/or usable by a computer or machine learning model (e.g., the data modeler 726).

The data preprocessor 724 may then clean the structured/formatted data. Specifically, the data preprocessor 724 may clean SR data. As stated, SR data includes text descriptions of building equipment faults and/or failures, as well as efficiency information associated with each service technician dispatch (e.g., truck roll) related to those faults, such as financial information, equipment performance information, etc. The data preprocessor 724 may clean the text data by removing formatting elements such as whitespaces, symbols, special characters, etc., that may hinder analysis by the data modeler 726. The data preprocessor 724 may also remove stop words from the SR data.

Responsive to cleaning the SR data, the data preprocessor 724 may extract text from the data. For example, each description included in the SR data may include the one or more fault codes included as being potentially responsible for the building equipment failure. Further, the CEP data may include a list of all possible fault codes associated with the building equipment. The data preprocessor 724 may identify the specific faults associated with and responsible for the failures of certain building equipment.

To identify the specific faults, certain algorithms and/or logic may be utilized or implemented by the data preprocessor 724. For example, sliding window word matching may be performed by the data preprocessor 724 between the description data included in the SR data and the fault code data included in the CEP data. For example, the data preprocessor 724 may identify and extract the fault code causing the fault for a particular piece of building equipment from the SR data. Word matching may be performed between the words in the description data of the SR data and the fault code data of the CEP data.

For example, a description from an SR data file may read: “We have observed a cyclic fault for leaving chilled liquid-low temperature.” The data preprocessor 724 may compare this text to the fault codes in the CEP data to identify a match between words in the description and words in each fault code. A match may refer to any instance of a word appearing in the description data also appearing in a fault code. The data preprocessor 724 may determine that a particular fault code is responsible for a fault described in the description data based on a determination that a match percentage (or other metric, such as number of words, etc.) between the description data and the fault code data is at or above a certain value (e.g., 80%, etc.). For example, responsive to a determination that at least 80% of the words included in the description data and the words included in a particular fault code match, the data preprocessor 724 may determine that that particular fault code is causing the failure described in the description data.

Once the text data is cleaned and fault codes are extracted, the data preprocessor 724 includes additional data or features to each identified fault or failure in order to allow the machine learning model to generate more accurate resource scores. For example, the data preprocessor 724 may generate and/or include penalty score information for each identified fault.

Penalty scores may refer to penalties incurred by the equipment due to particular faults experienced by the building equipment. For example, when the data preprocessor 724 determines that a fault of a piece of building equipment is a safety and/or health-related fault, a penalty may be applied. Penalty score information may include a penalty count (e.g., a number of penalties) applied for each piece of building equipment within a predefined time period (e.g., within five days from a date on which a description from the SR data was generated, etc.). The penalty score may be reduced each day past the date on which the fault occurred. The penalty score information may also indicate which types of faults (e.g., health related, safety related, etc.) have occurred for each piece of building equipment and how many of each type of fault have occurred for each piece of building equipment within a predefined time period (e.g., within the last five days, within the last week, etc.). In various embodiments, the penalty score may be applied to or included with the CPI data stored in the CEP database 730. In some embodiments, a piece of building equipment may have no associated penalty scores or penalty score information. In such embodiments, a value of “0” is assigned to the fault/piece of building equipment.

The data preprocessor 724 may also include warranty and/or contract data for each fault and/or piece of building equipment. The data preprocessor 724 may retrieve the relevant warranty and/or contract data from the central database or the NextGen database 734. As stated herein, warranty and contract data may indicate whether a piece of building equipment experiencing a fault is covered under a warranty, whether the warranty has expired, terms of a contract associated with the piece of building equipment, etc. When warranty or contract information is unavailable for a particular piece of building equipment, the data preprocessor 724 may treat the equipment as being out of warranty and may indicate as such. For example, a score of “0” may indicate that the piece of building equipment is under warranty and a score of “1” may indicate that the piece of building equipment is not under warranty.

The data preprocessor 724 may also include PSR data for each fault and/or piece of building equipment. For example, the data preprocessor 724 may retrieve the PSR information from the PSR database 732 or the central data repository. When PSR data is missing for a particular piece of building equipment, the data preprocessor 724 may utilize penalty score information to address the missing information. For example, the data preprocessor 724 may identify a similarity between the SR description data and the penalty score information using, for example, cosine similarity, kNN methods, etc.

Upon identifying and/or retrieving the information described above, the data preprocessor 724 generated a finalized dataset. The finalized dataset includes, for each fault and/or piece of building equipment, a cleaned and formatted description of the fault, an identified fault code, a penalty score and associated information, warranty information, and PSR information. The finalized dataset may be used by the data modeler 726 to both train the machine learning model and to generate a resource score for each fault.

A resource score may be a value (e.g., a number, a percentage, etc.) indicating a likelihood or propensity that dispatching a service technician to a site of a piece of building equipment experiencing a fault will be an efficient use of service provider resources. Efficiency of service provider resources as described herein may be determined by evaluating and comparing a particular metric or value against a threshold. Examples of metrics that may be used to evaluate efficiency of service provider resources include time, resources consumed, safety, energy loss resulting from allowing faults to persist, cost, etc. In some embodiments, a metric used to evaluate efficiency of service provider resources is a profitability associated with dispatching a service provider to service a piece of building equipment. For example, a piece of building equipment having a higher generated resource score may indicate that servicing the equipment will result in increased profit, increased energy efficiency of the building and/or piece of equipment, increased building safety, reduced energy or other resource consumption, etc. A higher resource score (e.g., a score above a threshold value, a score greater than another score, etc.) may therefore indicate that servicing the piece of building equipment should be prioritized against servicing pieces of building equipment having lower resource scores.

Using the dataset generated as described above, the data modeler 726 calculates a resource score for each fault or piece of building equipment that indicates a likelihood that dispatching a service technician to service the equipment on site will be an efficient use of service provider resources. As described herein, dispatching a service technician may refer to dispatching a service technician to a physical location of the building equipment experiencing the fault. The service technician may then perform one or more maintenance operations or fixes to resolve the equipment fault. In some embodiments, dispatching a service technician may refer to assigning a service technician to remotely resolve the faults.

The data modeler 726 may be or include a machine learning model (e.g., a large language model (LLM)) or other artificial intelligence model. Specifically, the data modeler 726 evaluates the various features of the dataset that may contribute to the efficiency associated with dispatching a service technician. The data modeler 726 may utilize historical data to perform a predictive analysis of efficiency. For example, the data modeler 726 can determine a resource score for a piece of building equipment experiencing a particular fault using historical data for another, previous fault having similar characteristics (e.g., the same type of building equipment, the same type of fault, etc.).

Further, each resource score may be calculated based on the various features associated with each fault in the dataset. Features include, for example, different penalties and penalty scores, such as safety fault penalties or warning fault penalties, fault counts, penalty counts, warranty status, and/or other pieces or types of information included in data stored in each of the databases 728-734. Each feature included in the resource score calculation may have an associated weight. As such, prior to generating the resource score, the data modeler 726 assigns a weight to each feature. For example, a lower weight may be assigned for a piece of building equipment that is under warranty and/or under contract relative to a piece of building equipment that is not under warranty and/or under contract. In some embodiments, weighting may be determined during data preprocessing. For example, when preprocessing the data, a score or value may be assigned to each feature (e.g., a value based on whether the equipment is under warranty, a value corresponding to the penalties and/or penalty scores of the equipment, etc.). The data modeler 726 may then calculate the resource score using the feature values.

Upon calculating a resource score for each piece of building equipment or fault, the data modeler 726 may prioritize or rank each of the failures based on the generated resource scores. Service technicians are dispatched to sites of equipment having a resource score at or above a predetermined threshold value. In some embodiments, the resource score being at or above the predetermined threshold value may indicate that dispatching a service technician to the site of the faulty equipment to service and resolve the fault will be an efficient use of resources (e.g., one or more metrics for efficiency are at or above a threshold level such that the equipment is causing efficiency rather than inefficiency), whereas dispatching a technician to any equipment having a resource score below the threshold value will not be an efficient use of resources (e.g., one or more metrics for efficiency are below a threshold level such that the equipment is operating inefficiently). For example, the resource score being at or above the predetermined threshold value may indicate that dispatching a service provider may cause efficiency, and the resource score being below the predetermined threshold value may indicate that dispatching the service provider may cause inefficiency.

In other embodiments, the resource score being at or above the predetermined threshold value may indicate that dispatching a service technician to the site of the faulty equipment to service and resolve the fault will be efficient or cause a certain amount of efficiency (e.g., a metric of efficiency, such as a profit, an energy efficiency, a reduction in energy consumption, a workflow efficiency, etc. may be above at or above a threshold value), whereas dispatching technicians to equipment having a resource score below the threshold value may still be efficient, but less efficient than dispatching a provider to equipment having a resource score above the threshold. For example, the resource score being at or above the predetermined threshold value may indicate that dispatching a service provider may cause more efficiency than an amount of efficiency experienced when a service provider is dispatched to a piece of equipment having a resource score below the threshold value.

To be able to generate or calculate accurate resource scores, the data modeler 726 may be trained. The data modeler 726 may be trained using the dataset generated by the data preprocessor 724. Specifically, the dataset may be divided into a training set and a validation set. The amount of data included in the training set may be greater than the amount of data included in the validation set. For example, 90% of the data in the dataset may be used for training and the remaining 10% may be used for validation. The data modeler 726 may be trained using one or more algorithms or machine learning methods. For example, the data modeler 726 may be trained using a random forest algorithm.

In various embodiments, a certain number of faults may be determined to be profitable enough to justify dispatching a service technician to the site of the faulty building equipment. In such embodiments, the target variable (e.g., determining whether a technician should be dispatched) is imbalanced, and using the dataset may lead to a poorly or improperly trained model. As such, to train the data modeler 726, a certain subset of the data, specifically the subset of the data where technicians are determined to be dispatched (e.g., a minority class of the data), may be used to train the data modeler 726.

After training the model, the trained data modeler 726 may be tested on the evaluation dataset. The data modeler 726 may subsequently be tuned to increase accuracy and improve generated outputs. Specifically, hyperparameters of the data modeler 726 are tuned to accurately capture or identify patterns within the dataset. For example, the data modeler 726 identifies or ranks an importance of different features of the dataset. In some embodiments, the data modeler 726 assigns a particular value (e.g., numerical value, percentage, etc.) to each feature indicating the identified importance. Features of the dataset may be, for example, different penalties and penalty scores, such as safety fault penalties or warning fault penalties, fault counts, penalty counts, warranty status, and the like. An importance of a particular feature may be predefined and correspond to a weight to be associated with that feature when calculating the resource score. The data modeler 726 may identify an importance of various features and retrain or fine tune the model by adding or removing features that are determined to be less important. For example, the data modeler 726 may remove features that have an importance value below a predefined threshold value.

To evaluate a performance of the data modeler 726, various metrics may be utilized, such as a confusion matrix, precision, recall, etc. Additionally, the resource score threshold value may be varied and outputs from the data modeler 726 are recorded for the various threshold values.

Upon generating the resource scores, the data modeler 726 may initiate one or more automated actions. These automated actions may cause a service provider to be dispatched to a location of the building equipment having a resource score at or above the predefined threshold value. For example, upon calculating the resource score for a piece of building equipment, the data modeler 726 compares the score to a threshold value. Responsive to a determination that the resource score is at or above the threshold value, the data modeler 726 determines that a service technician is to be dispatched to a location. To facilitate dispatch of the service technician, the data modeler 726 initiates one or more actions. For example, the data modeler 726 may assign a service technician to a piece of building equipment to service the fault. The data modeler 726 may assign a service technician based on one or more parameters, such as an availability of the service technician, a location of the service technician, a location of the building equipment, a severity of the fault, an urgency of resolution of the fault, etc. In some embodiments, the order in which equipment is serviced and technicians are dispatched may be based on the value of the resource score. For example, a fault having a highest resource score may be assigned a service technician and serviced before other faults in the dataset.

The data modeler 726 may generate and/or transmit a notification to the service technician selected to service the building equipment. The notification may include information such as a determined date and time to service the equipment, information about the equipment such as the type of equipment, a serial number, etc., information about the fault, historical service record information regarding the equipment, suggested actions to take to resolve the fault, etc.

Further, in various embodiments, the data modeler 726 determines that the resource score for a piece of building equipment is below the predetermined threshold value. Responsive to such a determination, the data modeler 726 determines that no service technician should be dispatched to the location of the building equipment. In such embodiments, the data modeler 726 may determine one or more remote repairs that can be performed to service the equipment.

Referring now to FIG. 8, a block diagram 800 illustrating a flow of processes performed by the predictive maintenance system 502 is shown, according to an example embodiment. The processes performed by the predictive maintenance system 502 can be categorized into three separate categories. Specifically, the processes can be categorized into data management 802, data analysis 804, and data modeling 806. Various components of the predictive maintenance system 502 may perform the processes described in FIG. 8. For example, and as will be described in greater detail herein, the data collector 720 and the data integrator 722 may perform data management 802 processes, the data preprocessor 724 may perform data analysis processes 804, and the data modeler 726 may perform data modeling 806 processes.

In data management 802, a first process of data collection 808 may be performed by the data collector 720. For example, as described above with respect to FIG. 7, data from a plurality of sources is collected by the data collector 720. Specifically, SR data 816, CEP data 818, PSR data 820, and NextGen Data 822 are collected from different sources (e.g., from databases 728-734). The data from these various sources relate to faults experienced by a plurality of pieces of building equipment and can include information such as fault information and descriptions, service records, service recommendations, revenue data, warranty data, etc. After data collection 808, data integration 810 may be performed by the data integrator 722. That is, relevant data from each of the data sources 816-822 may be integrated into a central data repository.

After data management 802 is performed, data analysis 804 may be performed by the data preprocessor 724. Data analysis 804 includes data preprocessing 812 that may be performed by the data preprocessor 724. Data preprocessing 812 includes a plurality of processes or actions performed to prepare the integrated data to be used to generate resource scores during data modeling 806. Data formatting 824 and text cleaning 826 are performed to format the data into a format usable by the data modeler 726. For example, data columns including irrelevant information are removed, special characters, symbols, whitespaces, and the like are removed, etc. Text extraction 828 may be performed to extract relevant fault information from the SR data 816.

Handle missing value 830 indicates that, for each fault, if a particular piece of data is missing from the integrated data, the data preprocessor 724 generates a value so that a resource score can be calculated. For example, a fault may have no associated warranty information (e.g., no or limited NextGen data 822 is associated with that particular fault). Lacking a specific type of data may cause the data modeler 726 to be unable to generate a resource score or generate an inaccurate resource score. As such, when the data preprocessor 724 encounters a missing value, a value may be generated. For example, when no warranty information is included, the data preprocessor 724 may include a value that indicates that the piece of equipment is not under warranty.

Data merging 832 may then be performed by the data preprocessor 724. That is, data for each fault may be synthesized so that, for example, a single entry including all information regarding a particular fault is generated. Multiple entries, each relating to a different fault, are merged to create a finalized dataset.

After data analysis 804, data modeling 806 may be performed by the data modeler 726. Specifically, predictive analytics 814 are performed. Data analytics 814 include model training 834. Model training is described above with respect to FIG. 7. For example, the generated, finalized dataset may be used to train the model to generate accurate resource scores using the data. Model testing 836 occurs to test the accuracy of the generated resource scores.

Model tuning 838 may be performed to identify specific features of the dataset that are most important to generation of the resource scores. Model validation 840 may be performed to validate the performance of the model. After the model has been validated, the model is deployed (e.g., at go live 842). After the model is deployed, data integration 810 occurs and the model generates resource scores that are used to dispatch service technicians.

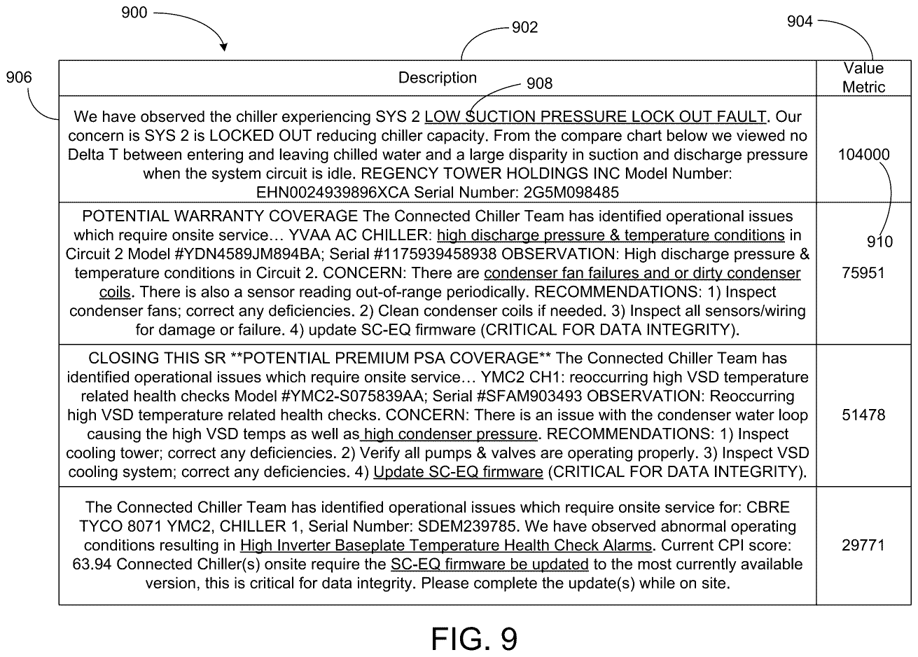

Referring now to FIG. 9, service record (SR) data 900 is shown, according to an example embodiment. The SR data 900 shows a plurality of service record entries, each for a different equipment fault, that may be included in the SR database 728. The SR data 900 includes a description 902 and a value metric 904. The SR data 900 may be cleaned by the data preprocessor 724 for use in generating resource scores.

The description 902 includes a text (e.g., narrative) formatted description of a fault experienced by a piece of equipment. The description includes, for example, an identified fault (shown in FIG. 9 as underlined text). The description 902 may further include: one or more observations made that led to the detection of the fault, one or more recommendations to resolve the fault, an equipment performance index of the equipment, a serial number of the equipment, an indication of the severity of the fault, etc.

Using a description 906 for a first fault as an example, the description includes a textual indication of a fault 908. Specifically, description 906 indicates that the fault 908 is that a chiller is experiencing a low suction pressure lockout fault. The description 906 further includes an indication of problems caused by the fault (e.g., reduced chiller capacity).

The SR data 900 further includes a value metric 904. The value metric 904 indicates a level of efficiency associated with dispatching a service technician to a location of the equipment to resolve the fault. The value metric 904 may be a specific metric associated with servicing the equipment that may be predetermined or dynamic. For example, the value metric 904 may be amount of carbon dioxide emitted after servicing the equipment, amount of carbon dioxide reduced after servicing the equipment, amount of energy expended after servicing the equipment, amount of energy saved after servicing the equipment, profit, time saved by servicing the equipment, etc. For example, a value metric 910 corresponding to description 906 indicates that a technician being dispatched to resolve the fault 908 results in 104,000 units (e.g., dollars) of revenue. In another example, the value metric 910 may indicate that a technician being dispatched to resolve the fault 908 results in 104,000 units (e.g., tons, etc.) of carbon dioxide being reduced.

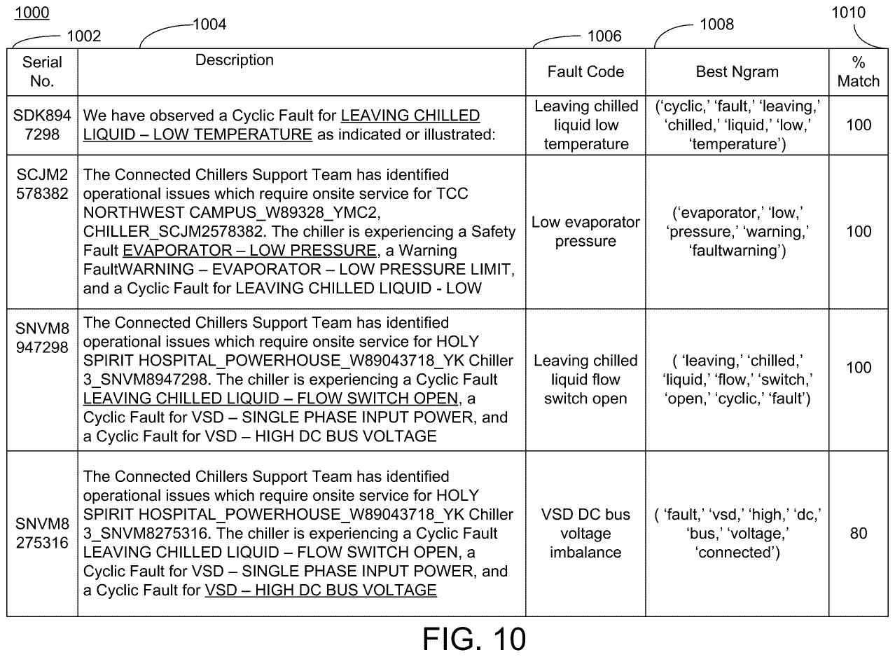

Referring now to FIG. 10, data 1000 is shown, according to an example embodiment. The data 1000 includes service record data and CEP data. The data 1000 includes a serial number 1002 of each piece of equipment experiencing a fault. In some embodiments, the serial number 1002 may be a different type of equipment identifier. The data 1000 further includes a description 1004. The description 1004 may be a cleaned description (e.g., the description has been formatted and cleaned by the data preprocessor 724).

The data 1000 further includes fault code data 1006. The fault code data 1006 may be generated based on an identification of the fault from the description 1004. For example, as described with respect to FIG. 7, the SR data is compared to the CEP data to identify a fault code. As such, matching logic (e.g., sliding window word matching logic) may be utilized to compare the words in the description 1004 with each fault in the CEP database. Based on the matching logic, one or more words matching between the description 1004 and a fault code from the CEP data are identified. For example, when the words from the description 1004 are compared to each CEP database entry, a fault code is identified that is most similar to the description 1004 (e.g., has the most words matching with the description 1004). The words identified as being common to the description 1004 and the most similar fault code are identified and listed in the best ngram data 1008. The fault code data 1006 shows the fault code identified as being the most similar to the description 1004. The percent match data 1010 indicates a percent match between the words in the fault code and the description. For example, the description may include words in addition to those included in the fault code. As such, the percent match data 1010 may indicate what percentage of the words in the fault code data 1006 are included in the description 1004.

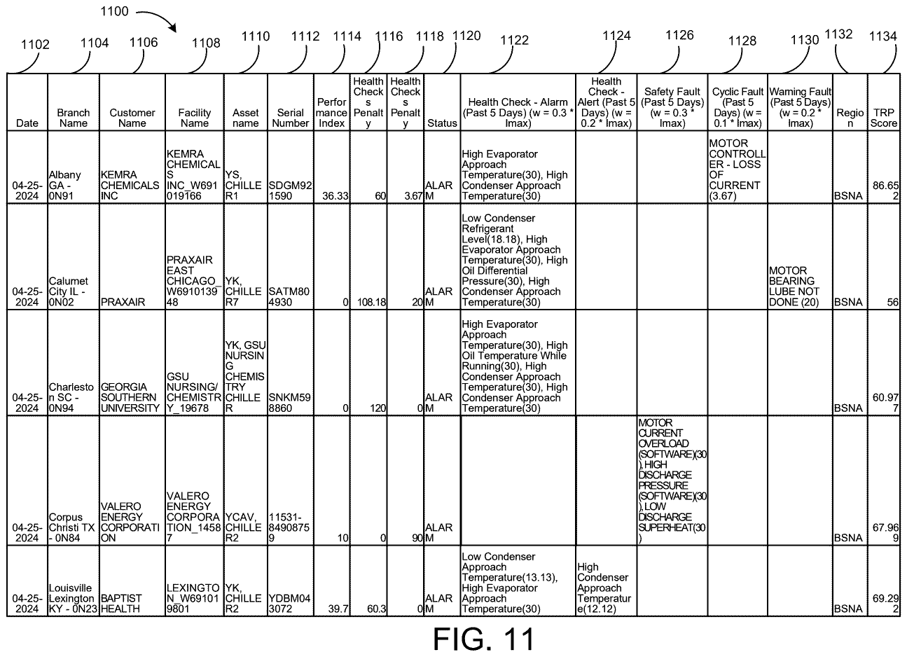

Referring now to FIG. 11, equipment performance index data 1100 is shown, according to an example embodiment. The equipment performance index data includes a date 1102 of the generation of the equipment performance index information, a name 1104 of a branch of a company utilizing the equipment, a name 1106 of the customer having the equipment, a name 1108 of the facility where the equipment is located, and a region 1132 indicating a region where the equipment is located.

The equipment performance index data 1100 further includes an asset name 1110 indicating a name of the building equipment and a serial number 1112 of the equipment. The equipment performance index data 1100 further includes a performance index value 1114 that shows the particular equipment performance index or score for the piece of equipment. The equipment performance index data 1100 further includes penalty information. Specifically, the equipment performance index data 1100 includes a health check penalty 1116 and a status check penalty 1118. As described with respect to FIG. 7, a health check penalty may be incurred when the equipment experiences a health-related fault. A status check penalty may be incurred when a status check is made regarding or for the equipment.

The status 1120 indicates a status of the equipment. For example, as shown in FIG. 11, a piece of equipment may be an “alarm” status indicating that an alarm is going off for the equipment (e.g., because the equipment is experiencing the fault). Different statuses may correspond to different states of the faults of the equipment. For example, an alarm status may be associated with the equipment when certain faults are occurring (e.g., when faults determined to be above a certain level of severity are occurring). An alert status may be associated with the equipment when faults determined to be below the certain level of severity are occurring.

The health check alarm status 1122 indicates a listing of faults associated with the building equipment that are health-related and cause an alarm status. As shown, the health check alarm status 1122 may show faults that have occurred within a predefined time period (e.g., within the last five days). As shown, the faults may have a corresponding weight used to calculate the health check penalty 1116. For example, the value of the fault may be multiplied by a multiplier (e.g., 0.3). The health check alert status 1124 may be similar to the health check alarm status 1122, but relates to faults that may be less severe and cause an alert status 1122 rather than an alarm status. As shown, when a health check alert status is generated, a value of the fault may be multiplied by a multiplier (e.g., 0.2) that is less than the multiplier associated with the health check alarm status 1122. As such, a penalty associated with a health-related fault may be less sever (e.g., having a smaller value) when the fault is less severe.

The equipment performance index data 1100 further includes a safety fault status 1126, a cyclic fault status 1128, and a warning fault status 1130. Each of the statuses may be similar to the health check alarm status 1122 and the health check alert status 1124 described above. For example, when the equipment experiences any of a safety fault, a cyclic fault, and/or a warning fault, the fault is included in the corresponding column. The value of the fault may be multiplied by a multiplier associated with that fault (e.g., in FIG. 11, a safety fault value is multiplied by 0.3, a cyclic fault value is multiplied by 0.1, and a warning fault value is multiplied by 0.2). Each of the fault values multiplied by the corresponding multiplier may contribute to the performance index value 1114, the health check penalty 1116 (when applicable, such as when the fault is a health-related fault), the status check penalty 1118 (when applicable, such as when the fault is a status-related fault), the penalty score, etc.

The equipment performance index data 1100 may further include the calculated resource score 1134, shown in FIG. 11 as a truck roll propensity (TRP) score 1134. As described herein, the resource score 1134 is indicative of a calculated probability, based on historic data and/or identified patterns in data relating to pieces of building equipment, that dispatching a service provider to a location of a faulty piece of building equipment to service the equipment is associated with a level of efficiency (e.g., amount of revenue, amount of reduced emissions, etc.) at or above a threshold level. As described herein, the models used to generate the resource score utilize CPI scores, fault information, warranty information, etc. In some embodiments, a resource score above a threshold value indicates that the service technician should be dispatched to the location of the equipment to resolve the fault. In some embodiments, a resource score below a threshold value may indicate that the service technician should be dispatched to the location of the equipment to resolve the fault.

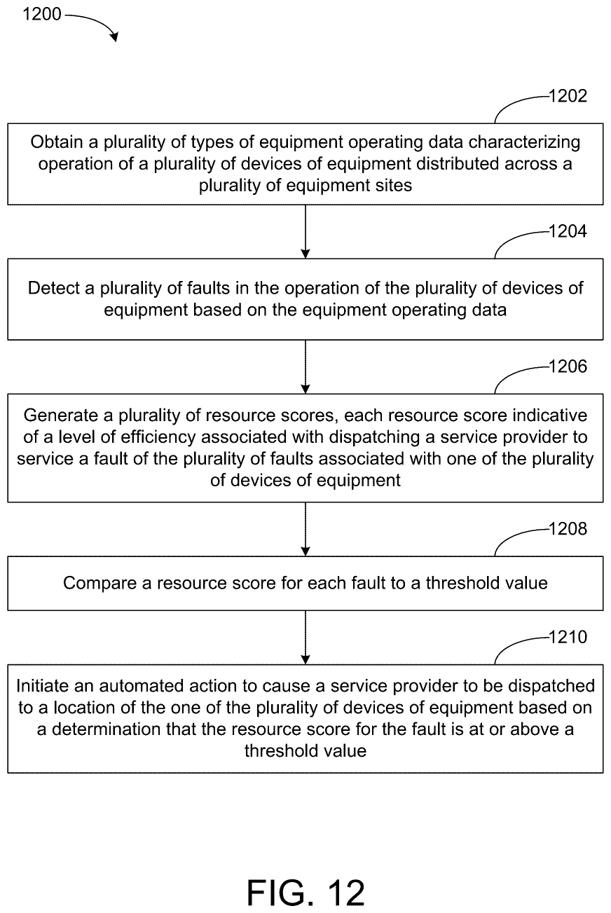

Referring now to FIG. 12, a flow diagram is shown for a method 1200. The method 1200 may be for determining whether a service technician should be dispatched to service a piece of building equipment experiencing a fault.

At process 1202, a plurality of types of equipment operating data are obtained. The plurality of types of equipment operating data characterize operation of a plurality of devices of equipment distributed across a plurality of equipment sites. The plurality of types of equipment operating data include: fault code data, penalty data, warranty data, service recommendation data, or service record data. The plurality of equipment sites may include a building site and the equipment comprise HVAC equipment located at the building site.

At process 1204, a plurality of faults in the operation of the plurality of devices of equipment are detected. The plurality of faults are detected based on the equipment operating data. The plurality of faults may be received by the data collector 720 from one or more of the databases 728-734.

At process 1206, a plurality of resource scores are generated. Each resource score is indicative of a potential level of efficiency associated with dispatching a service provider to service a fault of the plurality of faults.

In some embodiments, generating the plurality of resource scores includes formatting the plurality of types of equipment operating data associated with each fault of the plurality of faults, generating a dataset comprising the formatted plurality of types of equipment operating data associated with each fault, and analyzing, using a machine learning model, the formatted plurality of types of equipment operating data associated with each fault to generate a resource score for each fault of the plurality of faults. Analyzing the formatted plurality of types of equipment operating data includes weighting a value of each feature of a plurality of features of the equipment operating data according to information associated with each feature of the plurality of features. In some embodiments, the method 1200 further includes identifying that at least one of the features of the plurality of features is missing from the equipment operating data and generating a value for the missing at least one of the features.

In some embodiments, the method 1200 further includes ranking the plurality of faults based on the plurality of resource scores.

At process 1208, a resource score for each fault is compared to a threshold value. The threshold value may depend on the type of efficiency metric used to determine the level of efficiency. For example, in some embodiments, the resource score may be indicative of a level of efficiency defined by an amount of carbon dioxide emitted or reduced, an amount of revenue generated, an amount of energy expended or reduced, etc. Depending on which parameter is used, the threshold value may differ (and the generated resource scores may differ or vary).

At process 1210, an automated action is initiated to cause a service provider to be dispatched to a location of the one of the plurality of devices of equipment. The service provider may be dispatched to the location based on a determination that the resource score for the fault is at or above a threshold value.

In some embodiments, initiating the automated action includes causing one or more service technicians to perform one or more service activities to resolve the fault. In some embodiments, the action includes remotely addressing the fault. For example, the fault may be addressed remotely by having a service technician perform remote service or by having the system itself perform an automated remote fix (e.g., changing a control strategy, restarting the piece of equipment or device, utilizing a virtual agent, etc.). In embodiments where the plurality of faults are ranked, the method 1200 may further include dispatching a plurality of service providers to the locations of the plurality of devices according to the ranking of the plurality of faults.

In some embodiments, based on a determination that the resource score for the fault is below the threshold value, the method 1200 includes at least one of: adding the fault to a queue of faults to be addressed after each fault having a resource score above the threshold value is addressed or initiating an automated action to cause the fault to be resolved remotely.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A method comprising:
obtaining, by one or more processors, a plurality of types of equipment operating data characterizing operation of a plurality of devices of equipment distributed across a plurality of equipment sites;
detecting, by the one or more processors, a plurality of faults in the operation of the plurality of devices of equipment based on the equipment operating data;
generating, by the one or more processors, a penalty score for each of the plurality of devices of equipment based on a type of each of the plurality of faults;
generating, by the one or more processors, a plurality of resource scores, each resource score based in part on the generated penalty score for a corresponding device of equipment and indicative of a level of efficiency associated with dispatching a service provider to service a fault of the plurality of faults associated with one of the plurality of devices of equipment;
comparing, by the one or more processors, a resource score for each fault to a threshold value; and
initiating, by the one or more processors, an automated action to (i) cause a service provider to be dispatched to a location of the one of the plurality of devices of equipment based on a determination that the resource score for the fault is at or above a threshold value and (ii) cause the one of the plurality of devices of equipment to be serviced by repairing or replacing one or more components of the one of the plurality of devices of equipment, wherein servicing the one or the plurality of devices of equipment affects physical operation of the one of the plurality of devices of equipment by improving energy efficiency or reducing resource consumption of the one of the plurality of devices of equipment during the physical operation.

2. The method of claim 1, further comprising:
ranking the plurality of faults based on the plurality of resource scores; and
dispatching a plurality of service providers to the locations of the plurality of devices according to the ranking of the plurality of faults.

3. The method of claim 1, wherein generating the plurality of resource scores comprises:
formatting the plurality of types of equipment operating data associated with each fault of the plurality of faults;
generating a dataset comprising the formatted plurality of types of equipment operating data associated with each fault; and
analyzing, using a machine learning model, the formatted plurality of types of equipment operating data associated with each fault to generate a resource score for each fault of the plurality of faults.

4. The method of claim 3, wherein analyzing the formatted plurality of types of equipment operating data comprises:
weighting a value of each feature of a plurality of features of the equipment operating data according to information associated with each feature of the plurality of features.

5. The method of claim 4, further comprising:
identifying that at least one of the features of the plurality of features is missing from the equipment operating data; and
generating a value for the missing at least one of the features.

6. The method of claim 1, wherein initiating the automated action comprises causing one or more service technicians to perform one or more service activities to resolve the fault.

7. The method of claim 1, wherein the plurality of types of equipment operating data comprise at least one of fault code data, penalty data, warranty data, service recommendation data, or service record data.

8. The method of claim 1, further comprising, based on a determination that the resource score for the fault is below the threshold value, at least one of:
adding the fault to a queue of faults to be addressed after each fault having a resource score above the threshold value is addressed; or
initiating an automated action to cause the fault to be resolved remotely.

9. A system comprising:
a plurality of devices of equipment distributed across a plurality of equipment sites; and
a controller comprising one or more memories storing instructions thereon that, when executed by one or more processors, cause the one or more processors to:
obtain a plurality of types of equipment operating data characterizing operation of the plurality of devices of equipment;
detect a plurality of faults in the operation of the plurality of devices of equipment based on the equipment operating data;
generate a penalty score for each of the plurality of devices of equipment based on a type of each of the plurality of faults;
generate a plurality of resource scores, each resource score based in part on the generated penalty score for a corresponding device of equipment and indicative of a potential level of efficiency associated with dispatching a service provider to service a fault of the plurality of faults associated with one of the plurality of devices of equipment;
compare a resource score for each fault to a threshold value; and
initiate an automated action to (i) cause a service provider to be dispatched to a location of the one of the plurality of devices of equipment based on a determination that the resource score for the fault is at or above a threshold value and (ii) cause the one of the plurality of devices of equipment to be serviced by repairing or replacing one or more components of the one of the plurality of devices of equipment, wherein servicing the one or the plurality of devices of equipment affects physical operation of the one of the plurality of devices of equipment by improving energy efficiency or reducing resource consumption of the one of the plurality of devices of equipment during the physical operation.

10. The system of claim 9, wherein the instructions further cause the one or more processors to:
rank the plurality of faults based on the plurality of resource scores; and
dispatch a plurality of service providers to the locations of the plurality of devices according to the ranking of the plurality of faults.

11. The system of claim 9, wherein generating the plurality of resource scores comprises:
formatting the plurality of types of equipment operating data associated with each fault of the plurality of faults;
generating a dataset comprising the formatted plurality of types of equipment operating data associated with each fault; and
analyzing, using a machine learning model, the formatted plurality of types of equipment operating data associated with each fault to generate a resource score for each fault of the plurality of faults.

12. The system of claim 11, wherein analyzing the formatted plurality of types of equipment operating data comprises:
weighting a value of each feature of a plurality of features of the equipment operating data according to information associated with each feature of the plurality of features.

13. The system of claim 12, wherein the instructions further cause the one or more processors to:
identify that at least one of the features of the plurality of features is missing from the equipment operating data; and
generate a value for the missing at least one of the features.

14. The system of claim 9, wherein initiating the automated action comprises causing one or more service technicians to perform one or more service activities to resolve the fault.

15. The system of claim 9, wherein the plurality of types of equipment operating data comprise at least one of fault code data, penalty data, warranty data, service recommendation data, or service record data.

16. The system of claim 9, wherein the instructions further cause the one or more processors to, based on a determination that the resource score for the fault is below the threshold value, at least one of:
add the fault to a queue of faults to be addressed after each fault having a resource score above the threshold value is addressed; or
initiate an automated action to cause the fault to be resolved remotely.

17. One or more non-transitory computer-readable media storing instructions thereon that, when executed by one or more processors, cause the one or more processors to:
obtain a plurality of types of equipment operating data characterizing operation of a plurality of devices of equipment distributed across a plurality of equipment sites;
detect a plurality of faults in the operation of the plurality of devices of equipment based on the equipment operating data;
generate a penalty score for each of the plurality of devices of equipment based on a type of each of the plurality of faults;
generate a plurality of resource scores, each resource score based in part on the generated penalty score for a corresponding device of equipment and indicative of a potential level of efficiency associated with dispatching a service provider to service a fault of the plurality of faults associated with one of the plurality of devices of equipment;
compare a resource score for each fault to a threshold value; and
initiate an automated action to (i) cause a service provider to be dispatched to a location of the one of the plurality of devices of equipment based on a determination that the resource score for the fault is at or above a threshold value and (ii) cause the one of the plurality of devices of equipment to be serviced by repairing or replacing one or more components of the one of the plurality of devices of equipment, wherein servicing the one or the plurality of devices of equipment affects physical operation of the one of the plurality of devices of equipment by improving energy efficiency or reducing resource consumption of the one of the plurality of devices of equipment during the physical operation.

18. The non-transitory computer-readable media of claim 17, wherein the instructions further cause the one or more processors to:
rank the plurality of faults based on the plurality of resource scores; and
dispatch a plurality of service providers to the locations of the plurality of devices according to the ranking of the plurality of faults.

19. The non-transitory computer-readable media of claim 17, wherein generating the plurality of resource scores comprises:
formatting the plurality of types of equipment operating data associated with each fault of the plurality of faults;
generating a dataset comprising the formatted plurality of types of equipment operating data associated with each fault; and
analyzing, using a machine learning model, the formatted plurality of types of equipment operating data associated with each fault to generate a resource score for each fault of the plurality of faults.

20. The non-transitory computer-readable media of claim 19, wherein analyzing the formatted plurality of types of equipment operating data comprises:
weighting a value of each feature of a plurality of features of the equipment operating data according to information associated with each feature of the plurality of features.
